(19) United States
(12) Patent Application Publication
(10) Pub. No.: US 2023/0088218 A1
(43) Pub. Date: Mar. 23, 2023

(54) Cereal Box with Sieve

(71) Applicant: Xiaohong Yun, Vienna, VA (US)

(72) Inventor: Xiaohong Yun, Vienna, VA (US)

(21) Appl. No.: 17/481,228

(22) Filed: Sep. 21, 2021

(51) Int. Cl. B65D 25/04; B65D 43/16; A47J 47/08

(52) U.S. Cl. CPC B65D 25/04; B65D 43/162; A47J 47/08

(57) ABSTRACT

The invention is a container with a built-in sieve that separates crumbs from cereal. Holes in the sieve are small enough to allow cereal to stay in the upper compartment of the container while large enough to allow crumbs to fall into the lower compartment. A lid is attached to the lower compartment so the consumers can remove the crumbs conveniently at any time.

### CROSS-REFERENCES TO RELATED APPLICATIONS

Not Applicable

### BACKGROUND OF THE INVENTION

This invention relates to a container that allows the user to separate crumbs from the cereal and the option to remove the crumbs after they are separated.

Consumers have long been using containers to store cereal. Many inventions have been patented to improve the functionalities of the containers. For example, U.S. Pat. No. 10,421,595 invents a container that stores food and beverage snack. U.S. Pat. No. 9,944,439 invents a pivoting lid that is movable between an open and a closed position. U.S. Pat. No. 7,147,880 invents a container with separate compartments for milk and cereal.

While there are many improvements made to the function of a container, none of them addresses the issue of cereal crumbs in the container. When cereal is mixed or transported, crumbs invariably occur. Many consumers, especially young kids, do not enjoy eating cereal mixed with crumbs. As cereal is stored in the container, crumbs settle down in the bottom of container and as consumers reach the bottom of the container, many choose to either pour the cereal with the crumbs in trash. This increases waste and add cost to the consumer. The present invention provides a solution to the crumb problem.

### BRIEF SUMMARY OF THE INVENTION

The present invention introduces a sieve layer at the bottom section of container to allow crumbs fall into it while keeping the cereal in the upper section of container. Sieve can be either permanent attached to the cereal box or be removable. A lid is introduced at the bottom section so that crumbs separated from cereal can be poured out easily.

### BRIEF DESCRIPTION OF THE SEVERAL VIEWS OF THE DRAWING

FIG. 1: Perspective view of the container of the present invention with lower lid in closed position;

FIG. 2: Perspective view of the container of the present invention with lower lid in open position;

FIG. 3: Plan view of the sieve.

### DETAILED DESCRIPTION OF THE INVENTION

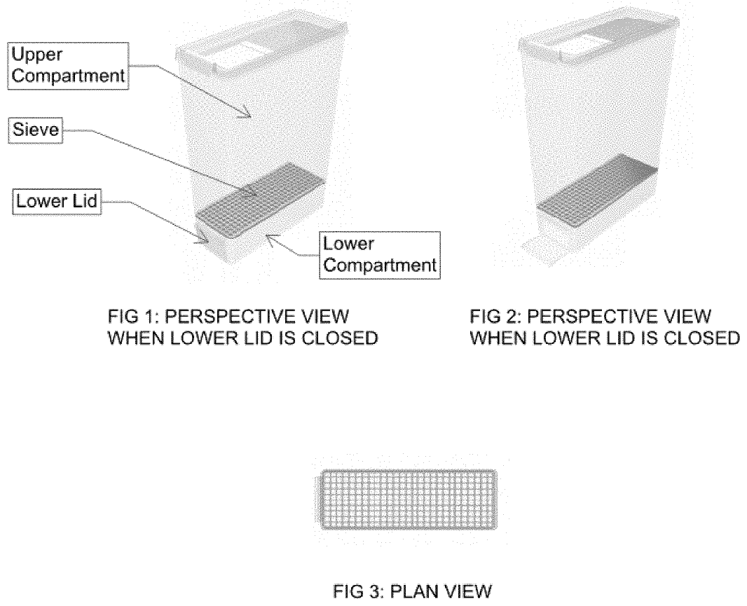

The present invention introduces a built-in sieve at the bottom section of container. The upper compartment is larger and stores cereal, and the lower compartment is smaller and stores crumbs that fall through the sieve. See FIG. 1.

Holes in the sieve are made in such a way that only crumbs can fall through into the lower compartment and cereal stay in the upper compartment.

A lid at the lower compartment allows consumers to easily remove the crumbs at any time without affecting the cereal in the upper compartment.

Having thus described the invention, what is claimed is:

1. A two-compartment container with a sifter or sieve in between to allow crumbs to fall into the lower compartment.

2. A lid that attaches to the lower compartment to allow the user to remove the crumbs conveniently at any time.
